(19) United States
(12) Patent Application Publication
(10) Pub. No.: US 2019/0304066 A1
(43) Pub. Date: Oct. 3, 2019

(54) SYNTHESIS METHOD OF CHINESE PRINTED CHARACTER IMAGES AND DEVICE THEREOF

(71) Applicant: ZhongAn Information Technology Service Co., Ltd., Shenzhen (CN)

(72) Inventor: Hongyu LI, Shenzhen (CN)

(21) Appl. No.: 16/433,302

(22) Filed: Jun. 6, 2019

Related U.S. Application Data
(63) Continuation of application No. PCT/CN2018/090189, filed on Jun. 7, 2018.

(30) Foreign Application Priority Data
Jun. 7, 2017 (CN) 201710423248.2

(51) Int. Cl. G06T 3/40; G06T 3/00; G06T 7/11; G06K 9/34

(52) U.S. Cl. CPC G06T 3/4084; G06T 3/0006; G06K 9/344; G06T 7/11; G06T 3/0056

(57) ABSTRACT

A synthesis method of Chinese printed character images and a device thereof are disclosed, which belong to the field of optical character recognition. The method includes performing at least one transformation on a standard character image to respectively generate at least one extended character image, and respectively merge the at least one extended character image with a background template to generate at least one synthesized character image. In embodiments of the present invention, a standard character image is transformed to generate an extended character image, thereby extending a Chinese printed character becomes much easier and faster; an extended character image and a background template are merged to generate a synthesized character image, thereby obtaining Chinese printed character image becomes much easier and faster.

### CROSS-REFERENCE TO RELATED APPLICATIONS

This application is a continuation application of International Application No. PCT/CN2018/090189 filed on Jun. 7, 2018, which claims priority to Chinese patent application No. 201710423248.2 filed on Jun. 7, 2017. Both applications are incorporated herein in their entireties by reference.

### TECHNICAL FIELD

Embodiments of the present invention relate to the field of optical character recognition, and in particular to a synthesis method of Chinese printed character images and a device thereof.

### BACKGROUND

With the development of computer and Internet technologies, more and more information is presented in digital form. Therefore, the use of deep neural network models to identify characters in digital information has become a research hotspot. Especially for the recognition of Chinese printed characters, due to the variety of character types, a large number of Chinese printed character images are needed as training samples to train the deep neural network model in order to obtain a deep neural network module with accurate recognition.

Therefore, how to quickly generate these Chinese printed character images has become an urgent problem to be solved.

### SUMMARY

In view of the above, embodiments of the present invention are devoted to providing a synthesis method of Chinese printed character images and a device thereof, so as to solve the problems in the prior art that Chinese printed characters cannot be easily and quickly extended and generated, and Chinese printed character images cannot be easily and quickly synthesized.

A first aspect of the present invention provides a synthesis method of Chinese printed character images, and the method includes: performing at least one transformation on a standard character image to generate at least one extended character image; merging the at least one extended character image with a background template to generate at least one synthesized character image.

In an embodiment of the present invention, the method further includes: generating a character according to a preset character requirement; performing a binarization process on the character to generate a standard character; and saving the standard character as the standard character image.

In an embodiment of the present invention, the preset character requirement includes any one or any combination of font type, font size, and font color.

In an embodiment of the present invention, the method further includes: segmenting and extracting a character in the image character; performing a binarization process and a first scaling transformation on the character to generate a standard character; and saving the standard character as the standard character image.

In an embodiment of the present invention, long-side resolution of the standard character image ranges from 32 to 64 pixels.

In an embodiment of the present invention, the method further includes: receiving a background image input by a user; and generating the background template from the background image.

In an embodiment of the present invention, the generating the background template according to the background image includes: performing a first proportional scaling transformation on the background image to generate the background template.

In an embodiment of the present invention, the first proportional scaling transformation includes: a bilinear interpolation or a bicubic interpolation.

In an embodiment of the present invention, a scaling ratio of the first proportional scaling transformation is determined by a ratio of resolution of the standard character image to character resolution of the background image.

In an embodiment of the present invention, the at least one transformation includes at least one of a fuzzy processing transformation, an affine transformation, a local shearing transformation, and a perspective transformation.

In an embodiment of the present invention, the fuzzy processing transformation includes one or both of a Gaussian blur processing and a Lattice blurring.

In an embodiment of the present invention, the Lattice blurring includes: randomly selecting a pixel point of a foreground character in a standard character image set including at least one standard character image; and extracting a first region corresponding to a size of a lattice fuzzy operator by using the pixel point as a center point; performing a dot-multiplication operation with the first region and the lattice fuzzy operator; and repeating the dot-multiplication operation to obtain a latticed character.

In an embodiment of the present invention, the lattice fuzzy operator refers to a strip operator whose width is shorter than a height.

In an embodiment of the present invention, the affine transformation includes at least one of a rotation transformation, a translation transformation, and a second scaling transformation.

In an embodiment of the present invention, the translation transformation includes: randomly setting upper, lower, left, and right boundary values of the standard character image to be translated; and zero padding the four boundary values.

In an embodiment of the present invention, the second scaling transformation includes: performing a second proportional scaling on the standard character image to be subjected to the second scaling transformation by a scaling factor.

In an embodiment of the present invention, the scaling factor ranges from 0.5 to 1.

In an embodiment of the present invention, the local shearing transformation includes: selecting a second region along a horizontal or vertical direction on the standard character image to be subjected to the local shearing transformation, and compressing the second region by keeping a height or a width of the second region unchanged to form a third region; and replacing a corresponding region of the second region in the standard character image with the third region.

In an embodiment of the present invention, the respectively merging the at least one extended character image with a background template includes according to a size of the extended character image, extracting a background templated region with a corresponding size in the background template; and performing a weighted merging process on the background template region and the at least one extended character image.

In an embodiment of the present invention, a weighting coefficient of the weighted merging process is determined by an average grayscale value of the background template region, wherein the average grayscale value is negatively correlated with the weighting coefficient.

A second aspect of the present invention provides a synthesis device of Chinese printed character images, and the device includes a memory, a processor and a computer program stored on the memory and executed by the processor, wherein when the computer program is executed by the processor, the processor implements the following steps: performing at least one transformation on a standard character image to respectively generate at least one extended character image; and respectively merging the at least one extended character image with a background template to generate at least one synthesized character image.

In an embodiment of the present invention, the processor further implements the following steps: generating a character according to a preset character requirement; performing a binarization process on the character to generate a standard character; and saving the standard character as the standard character image.

In an embodiment of the present invention, the preset character requirement includes any one or any combination of font type, font size and font color.

In an embodiment of the present invention, the processor further implements the following steps: segmenting and extracting a character in the image character; performing a binarization process and a first scaling transformation on the character to generate a standard character; and saving the standard character as the standard character image.

In an embodiment of the present invention, long-side resolution of the standard character image ranges from 32 to 64 pixels.

In an embodiment of the present invention, the processor further implements the following steps: receiving a background image input by a user; and generating the background template according to the background image.

In an embodiment of the present invention, when implementing the step of generating the background template according to the background image, the processor specifically implements the following step: performing a first proportional scaling transformation on the background image to generate the background template.

In an embodiment of the present invention, the first proportional scaling transformation includes a bilinear interpolation or a bicubic interpolation.

In an embodiment of the present invention, a scaling ratio of the first proportional scaling transformation is determined by a ratio of resolution of the standard character image to character resolution of the background image.

In an embodiment of the present invention, the at least one transformation includes at least one of a fuzzy processing transformation, an affine transformation, a local shearing transformation and a perspective transformation.

In an embodiment of the present invention, the fuzzy processing transformation includes one or both of a Gaussian blur processing and a lattice blurring.

In an embodiment of the present invention, the lattice blurring includes: randomly selecting a pixel point of a foreground character in a standard character image set including at least one standard image, extracting a first region corresponding to a size of a lattice fuzzy operator by using the pixel point as a center point; performing a dot-multiplication operation with the first region and the lattice fuzzy operator; and repeating the dot-multiplication operation to obtain a latticed character.

In an embodiment of the present invention, the lattice fuzzy operator refers to a strip operator whose width is shorter than a height.

In an embodiment of the present invention, the affine transformation includes at least one of a rotation transformation, a translation transformation and a second scaling transformation.

In an embodiment of the present invention, the translation transformation includes: randomly setting upper, lower, left, and right boundary values of the standard character image to be translated; and zero padding the four boundary values.

In an embodiment of the present invention, the second scaling transformation includes: performing a second proportional scaling on the standard character image to be subjected to the second scaling transformation by a scaling factor.

In an embodiment of the present invention, the scaling factor ranges from 0.5 to 1.

In an embodiment of the present invention, the local shearing transformation includes: selecting a second region along a horizontal or vertical direction on the standard character image to be subjected to the local shearing transformation, compressing the second region by keeping a height or a width of the second region unchanged to form a third region, and replacing a corresponding region of the second region in the standard character image with the third region.

In an embodiment of the present invention, when implementing the step of respectively merging the at least one extended character image with a background template, the processor specifically implements the following step: according to a size of the extended character image, extracting a background template region with a corresponding size in the background template; and performing a weighted merging process on the background template region and the at least one extended character image.

In an embodiment of the present invention, a weighting coefficient of the weighted merging process is determined by an average grayscale value of the background template region, and the average grayscale value is negatively correlated with the weighting coefficient.

A third aspect of the present invention provides a computer device, the computer device includes a memory, a processor and a computer program stored on the memory and executed by the processor, and when the computer program is executed by the processor, the processor implements the synthesis method of Chinese printed character images according to any one of the first aspect.

A forth aspect of the present invention provides a computer readable storage medium on which a computer program is stored, and when the computer program is executed by a processor, the processor implements the synthesis method of Chinese printed character images according to any one of the first aspect.

In embodiments of the present invention, a standard character image is transformed to generate an extended character image, thereby extending a Chinese printed character becomes much easier and faster; an extended character image and a background template are merged to generate a synthesized character image, thereby obtaining a Chinese printed character image becomes much easier and faster.

### BRIEF DESCRIPTION OF DRAWINGS

Embodiments are shown and described with reference to drawings. These drawings are used to clarify basic principles, thereby only showing the aspects necessary to understand the basic principles. These drawings are not proportional. In the drawings, the same reference numerals indicate similar features.

FIG. 1 is a schematic flow chart of a synthesis method of Chinese printed character images according to an embodiment of the present invention.

FIG. 2 is a schematic flow chart of a synthesis method of Chinese printed character images according to another embodiment of the present invention.

FIG. 3 is a schematic flow chart of a synthesis method of Chinese printed character images according to still another embodiment of the present invention.

FIG. 4 is a schematic structural diagram of a synthesis device of Chinese printed character images according to an embodiment of the present invention.

FIG. 5 is a schematic structural diagram of a synthesis device of Chinese printed character images according to another embodiment of the present invention.

FIG. 6 is a schematic flow chart of corresponding transformation steps of a synthesis method of Chinese printed character images according to an embodiment of the present invention.

FIG. 7 is a schematic flow chart of corresponding transformation steps of a synthesis method of Chinese printed character images according to another embodiment of the present invention.

FIG. 8 is a standard character image of the Chinese character “ [symbol] ” according to an embodiment of the present invention.

FIG. 9 are part of extended character images of the Chinese character “ [symbol] ” according to an embodiment of the present invention.

FIG. 10 are synthesized character images with a document background corresponding to extended character images in FIG. 9.

FIG. 11 is a standard character image of the Chinese character “ [symbol] ” according to an embodiment of the present invention.

FIG. 12 are part of extended character images of the Chinese character “ [symbol] ” according to an embodiment of the present invention.

FIG. 13 are synthesized character images with a ticket background corresponding to extended character images in FIG. 12.

FIG. 14 is a block diagram of a computer device for implementing a synthesis method of Chinese printed character images according to an embodiment of the present invention.

### DETAILED DESCRIPTION

A synthesis method of Chinese printed character images and a device thereof according to the present invention will be further described in detail with reference to the drawings and the specific embodiments, but the detailed description does not limit the present invention.

Printed character image recognition in documents and tickets is a branch of the field of optical character recognition (OCR), unlike handwriting recognition, the printed character image recognition focuses more on recognizing a machine printed character that appears in images, and is language-dependent.

Chinese printed character recognition is more complicated than English character recognition, because there are a large number of Chinese characters, for example, in the national Chinese standard character set GB2312, there are as many as 6763 characters in the first-class and second-class character set.

Recognizing such a large number of characters requires a good deep learning model, and training a good deep neural network model (DNN) requires a large number of high quality training samples, which should not only cover each Chinese character, but also have thousands of variations for each character, and can reflect background changes in different application scenarios.

So far, there is no a public large-scale Chinese printed character set, and it is also unrealistic to manually design and generate different training samples for thousands of Chinese characters. At present, extension of a Chinese character set mainly adopts a nonlinear transformation method to perform some simple preprocessing, and other extension incorporates a distortion model to generate character variants.

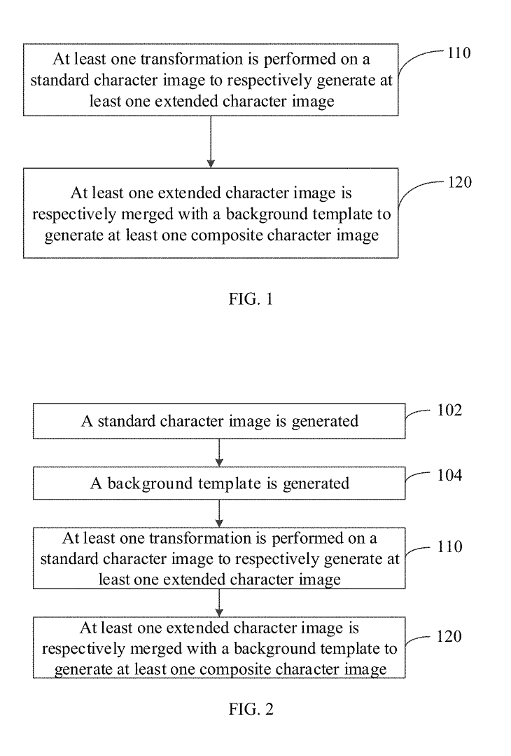

However, these methods have not been able to form a holistic solution, especially cannot adapt to variations of application requirements. Therefore, a synthesis method of Chinese print character images is urgently needed, which can make Chinese printed characters extend and generate easily and quickly, and adapts to various application requirements. Based on this, the present invention provides a synthesis method of Chinese printed character images and a device thereof to solve the above problems. The synthesis method of Chinese printed character images and the device thereof will be described below with reference to the accompanying drawings. FIG. 1 is a schematic flow chart of a synthesis method of Chinese printed character images according to an embodiment of the present invention, and an execution body of the method may be a synthesis device of Chinese printed character images.

In step 110, at least one transformation is performed on a standard character image to respectively generate at least one extended character image.

Specifically, in order to simulate transformation scenarios and application scenarios of different characters, a standard character may be transformed according to a transformation requirement input by a user, thereby generating a character extension set. In this case, the transformation requirement may correspond to at least one transformation, the transformation on a standard character may be a transformation on a standard character image, and the at least one extended character image, which is generated, may constitute a character extension set. Further, a synthesis device of Chinese printed character images may perform a transformation on a standard character image to obtain an extended character image. In this case, the standard character may be a character generated after performing a binarization process on a Chinese first-class character, a Chinese second-class character or other character, and the standard character image may be an image form of the character. Further, the standard character image, on which the synthesis device of Chinese printed character images performs a transformation, may be generated in the previous step, may be read from a storage medium, or may be obtained by other means, the source of the standard character image is not limited herein.

In addition, the above-described transformation may be any transformation manner on the standard character image, and as long as there is an application scenario for the transformed character, the transformation manner of the standard character image is not limited herein. The extended character image may be an image of any form of the character in any application scenario.

For example, a transformation requirement input by a user may be received first, and then transformations are performed on a standard character, according to the transformation requirement, to generate a corresponding character extension set. Specifically, the transformation requirement may correspond to at least one transformation, the standard character may be a standard character image, and the character extension set may be composed of the at least one extended character image.

In step 120, at least one extended character image is respectively merged with a background template to generate at least one synthesized character image.

Specifically, in some application scenarios of Chinese characters, there may be a background, and therefore, an extended character image and a background template may be merged to generate a character image that conforms to the application scenario, thereby training a deep neural network model in this application scenario.

For example, the at least one extended character image may constitute a character extension set, and therefore, an extended character in the character extension set may be merged with a background template to generate a synthesized character image. In this case, the extended character may be an extended character image.

It should be understood that the above-described synthesis method of Chinese printed character images may be proposed to meet various application requirements which are about Chinese printed character images. The application requirements may include providing a large number of high quality training samples for training a deep neural network model, and the samples usually can not only cover each Chinese character which has thousands of variations, but also reflect background changes in different application scenarios, so that the deep neural network model trained by the training samples can effectively recognize a wide variety of Chinese characters.

In embodiments of the present invention, a standard character image is transformed to generate an extended character image, thereby extending a Chinese printed character becomes much easier and faster; an extended character image and a background template are merged to generate a synthesized character image, thereby obtaining a Chinese printed character image becomes much easier and faster.

In addition, the above-described synthesis method of Chinese printed character images can meet various application requirements which are about Chinese printed character images; the method can provide a large number of high quality training samples for training a deep neural network model, and the samples usually can not only cover each Chinese character which has thousands of variations, but also reflect background changes in different application scenarios, so that the deep neural network model trained by the training samples can effectively recognize a wide variety of Chinese characters; and the method may simulate the latticed effect and the local distortion effect of a printed character to generate realistic character samples, thereby training the deep learning model easily.

FIG. 2 is a schematic flow chart of a synthesis method of Chinese printed character images according to another embodiment of the present invention. In this case, FIG. 2 may be a further embodiment of FIG. 1

In step 102, a standard character image is generated.

In another embodiment of the present invention, the above-described method may further include the step of generating a standard character image. Specifically, the standard character image may be generated by the following steps: generating a character according to a preset character requirement; performing a binarization process on the character to generate a standard character; and saving the standard character as the standard character image.

For example, the corresponding standard character may be generated by receiving the character requirement input by a user. It should be understood that, in this case, the preset character requirement may be a character requirement which is input by a user, and the character requirement corresponds to the standard character, or the preset character requirement may be obtained by a reading operation, the source of the preset character requirement is not limited herein.

Further, for example, the user may select a font style as the character requirement to input, and therefore, a corresponding Chinese first-class character, a corresponding Chinese second-class character or other corresponding character may be automatically generated. A standard character may be generated by performing a binarization process on the first-class character, the second-class character or the other character, and then the standard character may be saved as a corresponding standard character image.

In another embodiment of the present invention, the character requirement may include any one or any combination of font type, font size and font color.

Specifically, in order to synthesize a standard character image, a standard character may be generated first. In this case, a corresponding standard character may be generated according to a character requirement input by a user. The character requirement may include specifying a font, i.e., a font style may be specified, the font style may include font type, font size, font color and so on, and then the corresponding standard character, according to the character requirement, may be generated through a character library.

In another embodiment of the present invention, a standard character image may also be generated by the following steps: segmenting and extracting a character in the image character; performing a binarization process on the character to generate a standard character; and saving the standard character as a standard character image.

Specifically, in order to synthesize a character image, a standard character may be generated first, and therefore, a corresponding standard character may be generated by receiving an image character input by a user. In this case, the corresponding standard character may be generated according to the image character, the image character gives a character in an image form, and the corresponding standard character may be generated by processing the image character. In addition, the image character may be input by a user, or may be obtained by a reading operation, the source of the image character is not limited herein.

For example, when the segmented and extracted character is close to or equal to a standard character, the standard character may be obtained only by performing a binarization process on the segmented and extracted character.

In another embodiment of the present invention, after performing the binarization process on the character, the method may further include performing a first scaling transformation on the character.

Specifically, in order to obtain the standard character, both the binarization process and the first scaling transformation may be performed on the character.

For example, when the segmented and extracted character is not close to a standard character, the standard character may be obtained by performing the binarization process and the first scaling transformation on the character. In this case, the first scaling transformation may be a proportional scaling transformation, may be a non-proportional scaling transformation, may be performed one time, or may be performed multiple times, the type of the scaling transformation and the number of the scaling transformation are not limited herein.

In another embodiment of the present invention, long-side resolution of the standard character image ranges from 32 to 64 pixels.

For example, the resolution of the standard character image may be x1×y1, where 32≤x1≤64, 32≤y1≤64, and 0.5≤y1/x1≤1.5.

In step 104, a background template is generated.

In another embodiment of the present invention, the above-described method further includes generating a background template.

Specifically, the background template may be generated by the following steps: receiving a background image input by a user; and generating the background template according to the background image.

Further, in order to simulate an application scenario of a character in many different backgrounds, a background template may be used to represent the background in which the character is located. The background template may be obtained by a background image input by a user. For example, the background image may be a background image input by a user, and therefore, a corresponding background template may be generated according to the background image input by the user, thereby generating training samples of a character under the background template.

In another embodiment of the present invention, the generating a background template according to a background image may include performing a first proportional scaling transformation on the background image to generate the background template.

Specifically, in this case, since the resolution of the character in the background image is usually different from the resolution of the standard character image, the background image is generally not directly used to synthesize a character image, and a first proportional scaling transformation may be performed first on the background image in order to generate a background template, so that the character resolution of the background template is close to or equal to the resolution of the standard character image, and the background template can be directly used to synthesize a character image.

For example, in another embodiment of the present invention, a scaling ratio of the first proportional scaling transformation may be determined by a ratio of resolution of the standard character image to character resolution of the background image. For example, the resolution of the standard character image may be assumed as x1×y1. If the character resolution of the background image which is acquired in a practical application is x2×y2, the scaling ratio r of the first proportional scaling transformation may be calculated by the following equation: r=max(x1, y1)/max(x2, y2).

In another embodiment of the present invention, the first proportional scaling transformation may include a bilinear interpolation or a bicubic interpolation.

In another embodiment of the present invention, the at least one transformation includes at least one of a fuzzy processing transformation, an affine transformation, a local shearing transformation and a perspective transformation.

Due to the variety of requirements in reality, taking Chinese printed characters recognition as an example, the Chinese printed character to be recognized usually has some features such as printed fuzzy, angle tilt, positional shift, size change, locally small size of a printed character caused by paper bending deformation, radial distortion of a character generated by mobile phone photographing and so on, and therefore, there are transformation requirements corresponding to these features. Transformations corresponding to the above-described are performed according to the transformation requirements, so that the training samples can simulate a scenario in which a character has different transformations. For the perspective transformation, a small angle is usually adopted, that is because distortion too much can easily bring more uncertain factors to the character extension set, and this is not conducive to model training. Usually parameters of the perspective transformation are randomly selected, which can effectively extend character samples and effectively simulate character changes in a practical application scenario.

The above-described transformations correspond to corresponding transformation requirements, and the corresponding transformation requirements include simulating the various features of the Chinese printed character to be recognized. For example, the fuzzy processing transformation simulates the printed fuzzy feature, the affine transformation simulates the features of angle tilt, positional shift and size change, the local shearing transformation simulates the feature of locally small size of a printed character caused by paper bending deformation, and the perspective transformation simulates the feature of radial distortion of a character generated by mobile phone photographing.

In another embodiment of the present invention, the fuzzy processing transformation may include one or both of a Gaussian blur processing and a Lattice blurring.

The fuzzy processing generally corresponds to the printed fuzzy feature which exits in the Chinese printed character to be recognized. The Gaussian blur processing is a commonly used manner of the fuzzy processing, and the Lattice blurring is mainly used in the fuzzy processing of the latticed font in such as invoices.

For example, when a user requests to adopt the latticed font, the Lattice blurring may be adopted as the corresponding transformation.

In another embodiment of the present invention, the Lattice blurring may include randomly selecting a pixel point of a foreground character in a standard character image set including at least one standard character image, extracting a first region corresponding to a size of a lattice fuzzy operator by using the pixel point as a center point; performing a dot-multiplication operation with the first region and the lattice fuzzy operator; and repeating the dot-multiplication operation to obtain a latticed character.

Specifically, when a user requests to adopt the latticed font, the lattice fuzzy operator is usually used as the fuzzy processing to process a standard character. In this case, the lattice fuzzy operator may be a strip operator whose essence is a strip kernel, and may be used to simulate the fuzzy effect produced by latticed font printing. In addition, the repeated number of the dot-multiplication operation may be several times, i.e., the repeated number of the dot-multiplication operation may be one time or a plurality of times, which is not limited herein.

In another embodiment of the present invention, the lattice fuzzy operator refers to a strip operator whose width is shorter than a height.

For example, the lattice fuzzy operator is a strip operator whose width may be 1 pixel and the height may be randomly generated.

In another embodiment of the present invention, the affine transformation may include at least one of a rotation transformation, a translation transformation and a second scaling transformation.

Specifically, the affine transformation may generally correspond to the features, such as the angle tilt, the positional shift, the size change and so on, which exits in a Chinese printed character to be recognized. For example, the rotation transformation may simulate the feature of the angular tilt, the translation transformation may simulate the feature of the positional shift, and the second scaling transformation may simulate the feature of the size change. Further, the rotation transformation is usually small in angle, so that a character extension set may generally include a character at various angles, and a standard character image extension set may include a standard character image at various angles.

In another embodiment of the present invention, the translation transformation may include: randomly setting upper, lower, left, and right boundary values of a standard character image to be translated; and zero padding the four boundary values.

In an embodiment of the present invention, the second scaling transformation includes: performing a second proportional scaling on the standard character image to be subjected to the second scaling transformation by a scaling factor.

In an embodiment of the present invention, the scaling factor may range from 0.5 to 1.

The above-described translation transformation and the second scaling transformation are simple and efficient, so that they can be used in combination.

In another embodiment of the present invention, the local shearing transformation may include selecting a second region along a horizontal or vertical direction on the standard character image to be subjected to the local shearing transformation, compressing the second region by keeping a height or a width of the second region unchanged to form a third region, and replacing a corresponding region of the second region in the standard character image with the third region.

Specifically, the local shearing transformation may usually correspond to the feature of locally small size of a printed character caused by the paper bending deformation which exits in the Chinese printed character to be recognized.

In another embodiment of the present invention, respectively merging the at least one extended character image with a background template may include according to a size of the extended character image, extracting a background template region with a corresponding size in the background template; and performing a weighted merging process on the background template region and the at least one extended character image.

Specifically, in order to minimize space occupation and recognition calculation amount, according to a size of the extended character image, the background template region with a corresponding size may be extracted in the background template, and then the weighted merging process is performed on the background template region and the at least one extended character image. In this case, the extended character image and the background template can usually be matched and merged with the above-described steps, thereby generating a synthesized character image. The matching may include a size matching and a weight matching, and the weight may usually include a grayscale weight.

In an embodiment of the present invention, a weighting coefficient of the weighted merging process may be determined by an average grayscale value of the background template region, and the average grayscale value is negatively correlated with the weighting coefficient.

Specifically, since a grayscale value of an extended character image is generally relatively fixed, the weighting coefficient is generally determined by the average grayscale value of the background template, and the larger the average grayscale value, the smaller the weighting coefficient.

It should be understood that the character in the standard character image involved in the above-described embodiments may correspond to an initial state of the character in any application scenario before undergoing any transformation, i.e., a character in any application scenario may be generated after the corresponding transformation is performed on a character in the corresponding standard character image, and the character in the standard character image may be called a standard character.

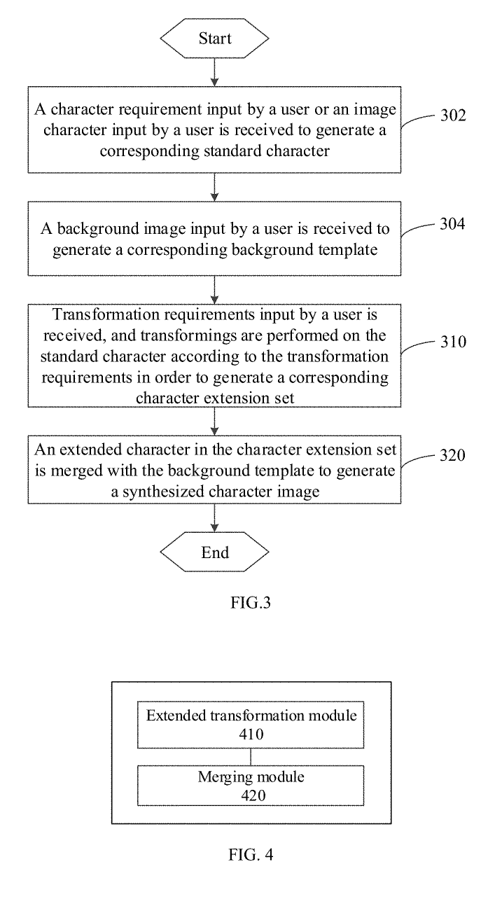

FIG. 3 is a schematic flow chart of a synthesis method of Chinese printed character images according to still another embodiment of the present invention.

In step 302, a character requirement input by a user or an image character input by a user is received to generate a corresponding standard character.

Specifically, the corresponding standard character may be generated according to the character requirement or the image character. In order to facilitate the subsequent transformation, the standard character may be saved as an image form, i.e., the standard character is saved as the standard character image.

In step 304, a background image input by a user is received to generate a corresponding background template.

In order to associate a character with a scenario, a background template needs to be generated in order to form training samples in which the character matches the background template. In this case, the background template may be generated according to a background image input by a user.

In step 310, transformation requirements input by a user is received, and transformations are performed on the standard character according to the transformation requirements in order to generate a corresponding character extension set.

Different transformation requirements may be used for different training purposes and for different training samples. In this case, a user may specify transformation requirements, and therefore, the transformation requirements input by the user needs to be received first, and then transformations are performed on a standard character according to the transformation requirements. It should be understood that the transformation on the standard character is the transformation on a standard character image, and the generated transformed standard character image may be referred to as a character extension image. When there is a plurality of transformation requirements, a plurality of character extension images may be generated, and thus the plurality of the character extension images may constitute a character extension set.

In step 320, an extended character in the character extension set is merged with the background template to generate a synthesized character image.

The extended character in the character extension set is an extended character image in the character extension set, and a synthesized character image may be generated by merging the extended character image with the background template.

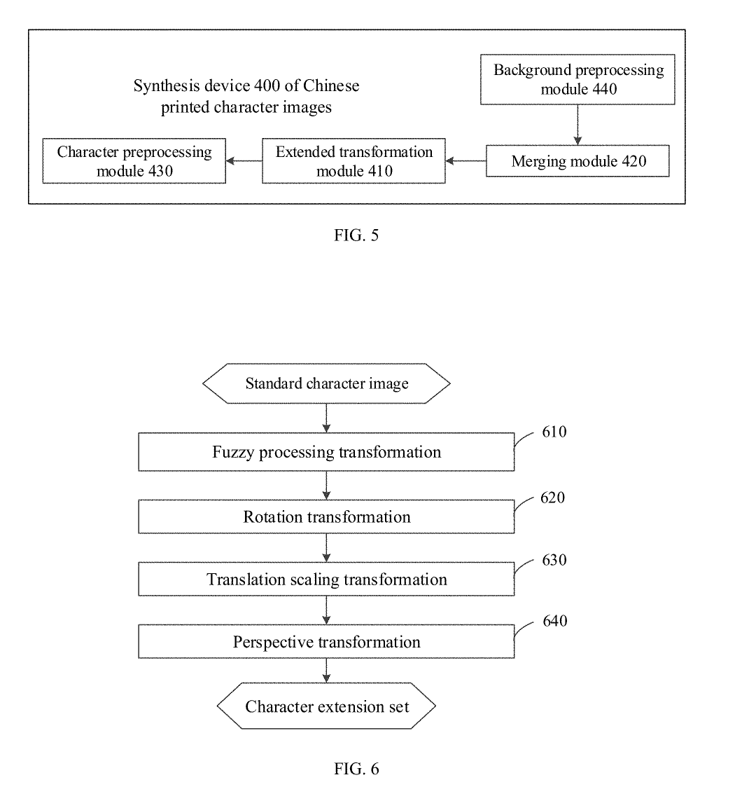

The synthesis method of Chinese printed character images according to the embodiments of the present invention is described above, and a synthesis device of Chinese printed character images according to the embodiments of the present invention is described below with reference to FIG. 4 and FIG. 5.

FIG. 4 is a schematic structural diagram of a synthesis device 400 of Chinese printed character images according to an embodiment of the present invention.

According to embodiments of the present invention, as shown in FIG. 4, the synthesis device 400 of Chinese printed character images may include an extended transformation module 410, configured to perform at least one transformation on a standard character image to respectively generate at least one extended character image; and a merging module 420, configured to respectively merge the at least one extended character image with a background template to generate at least one synthesized character image.

In embodiments of the present invention, a standard character image is transformed to generate an extended character image, thereby extending a Chinese printed character becomes much easier and faster; an extended character image and a background template are merged to generate a synthesized character image, thereby obtaining a Chinese printed character image becomes much easier and faster.

FIG. 5 is a schematic structural diagram of a synthesis device 400 of Chinese printed character images according to another embodiment of the present invention.

In another embodiment of the present invention, as shown in FIG. 5, the device 400 further includes a character preprocessing module 430, configured to generate a character according to a preset character requirement; perform a binarization process on the character to generate a standard character; and save the standard character as the standard character image.

In another embodiment of the present invention, the preset character requirement includes any one or any combination of the following: font type, font size and font color.

In another embodiment of the present invention, as shown in FIG. 5, the device 400 further includes a character preprocessing module 430, configured to segment and extract a character in the image character; perform a binarization process and a first scaling transformation on the character to generate a standard character; and save the standard character as the standard character image.

In another embodiment of the present invention, long-side resolution of the standard character image ranges from 32 to 64 pixels.

In another embodiment of the present invention, as shown in FIG. 5, the device 400 further includes a background preprocessing module 440, configured to receive a background image input by a user; and generate the background template according to the background image.

In another embodiment of the present invention, the background preprocessing module 440 performs a first proportional scaling transformation on the background image to generate the background template.

In another embodiment of the present invention, the first proportional scaling transformation includes a bilinear interpolation or a bicubic interpolation.

In another embodiment of the present invention, a scaling ratio of the first proportional scaling transformation is determined by a ratio of resolution of the standard character image to character resolution of the background image.

In another embodiment of the present invention, the at least one transformation includes at least one of a fuzzy processing transformation, an affine transformation, a local shearing transformation and a perspective transformation.

In another embodiment of the present invention, the fuzzy processing transformation includes one or both of a Gaussian blur processing and a Lattice blurring.

In another embodiment of the present invention, the Lattice blurring includes randomly selecting a pixel point of a foreground character in a standard character image set including at least one standard character image , extracting a first region corresponding to a size of a lattice fuzzy operator by using the pixel point as a center point; performing a dot-multiplication operation with the first region and the lattice fuzzy operator; and repeating the dot-multiplication operation to obtain a latticed character.

In another embodiment of the present invention, the lattice fuzzy operator includes a strip operator whose width is shorter than a height.

In another embodiment of the present invention, the affine transformation includes at least one of a rotation transformation, a translation transformation and a second scaling transformation.

In another embodiment of the present invention, the translation transformation includes randomly setting upper, lower, left, and right boundary values of the standard character image to be translated; and zero padding the four boundary values.

In another embodiment of the present invention, the second scaling transformation includes performing a second proportional scaling on the standard character image to be subjected to the second scaling transformation by a scaling factor.

In another embodiment of the present invention, the scaling factor ranges from 0.5 to 1.

In another embodiment of the present invention, the local shearing transformation includes selecting a second region along a horizontal or vertical direction on the standard character image to be subjected to the local shearing transformation, compressing the second region by keeping a height or width of the second region unchanged to form a third region and replacing a corresponding region of the second region in the standard character image with the third region.

In another embodiment of the present invention, the merging module 420, according to a size of the extended character image, extracts a background template region with a corresponding size in the background template, and performs a weighted merging process on the background template region and the at least one extended character image.

In another embodiment of the present invention, a weighting coefficient of the weighted merging process is determined by an average grayscale value of the background template region, and the average grayscale value is negatively correlated with the weighting coefficient.

It should be understood that each module in the synthesis device of Chinese printed character images provided by the above-described embodiments corresponds to a method step of the above-described synthesis method of Chinese printed character images. Accordingly, the operations and features described in the above-described method steps are also applicable to the device and the corresponding modules included in the device, and the repeated contents are not described herein again.

Embodiments of the present invention are described below with reference to specific examples.

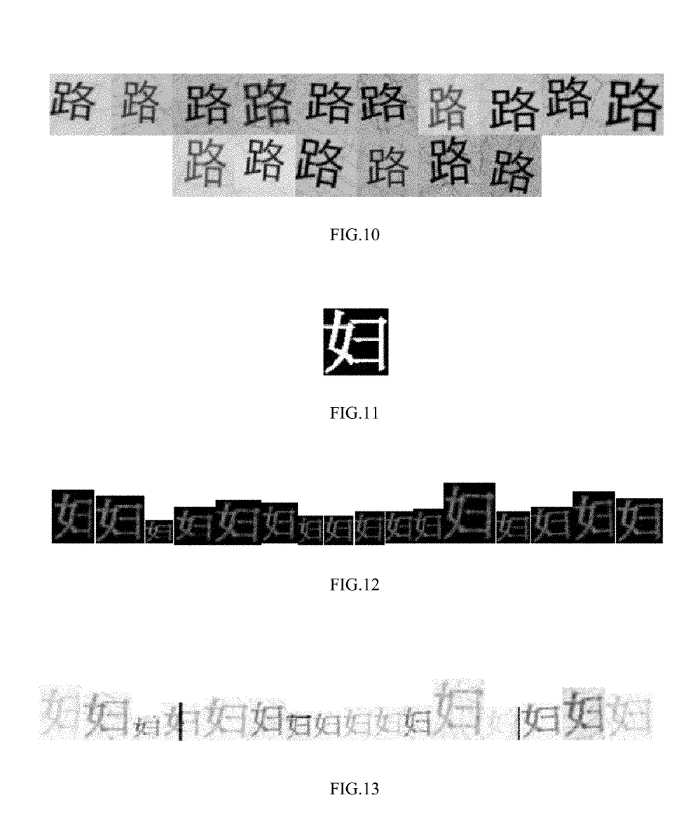

FIG. 6 is a schematic flow chart of corresponding transformation steps of a synthesis method of Chinese printed character images according to an embodiment of the present invention. FIG. 8 is a standard character image of the Chinese character “ [symbol] ” according to an embodiment of the present invention. FIG. 9 are part of extended character images of the Chinese character “ [symbol] ” according to an embodiment of the present invention. FIG. 10 are synthesized character images with a document background corresponding to extended character images in FIG. 9.

Referring to FIG. 3, FIG. 5 and FIG. 6, in an embodiment, the synthesis method of Chinese printed character images shown in FIG. 3 may be executed by the synthesis device of Chinese printed character images shown in FIG. 5. In this case:

The character preprocessing module 430 may execute the step 302, specifically:

When the character requirement input by a current user is “standard fine black font”, the character preprocessing module 430 may automatically generate a Chinese first-class character, a Chinese second-class character, an English letter and a number in the standard fine black font after receiving the character requirement input by the current user, perform a binarization process on the character to generate a standard character, and then save the standard character as a standard character image corresponding to the standard character. A standard character image of the Chinese character “ [symbol] ” may be as shown in FIG. 8.

The background preprocessing module 440 may execute the step 304, specifically:

After a background image is input by a user, the background preprocessing module 440 receives the background image, determines a scaling ratio of the background image according to resolution of a character appeared in the input background image, and then performs a first proportional scaling in a bilinear interpolation or a bicubic interpolation manner to generate a corresponding background template. In this embodiment, resolution of a standard character image is 32×30, and resolution of a character appeared in the background image acquired in a practical application is 64×62, and the scaling ratio r of the background image is r=max(32,30)/max(64,62)=0.5.

The extended transformation module 410 may execute the step 310, specifically:

As shown in FIG. 6, the step may specifically include the following transformation steps:

In step 610, the extended transformation module 410 receives the standard character image in the step 302, and performs a fuzzy processing transformation on the standard character image according to a received transformation requirement input by a user. In this embodiment, the fuzzy processing transformation is a Gaussian blur processing transformation.

In step 620, the extended transformation module 410 performs a rotation transformation on the result of the above-described fuzzy processing transformation according to a received transformation requirement input by a user, and the angle of the rotation transformation does not exceed 5 degrees.

In step 630, the extended transformation module 410 performs a translation scaling transformation on the result of the above-described rotation transformation according to a received transformation requirement input by a user. In this embodiment, a simple and efficient translation scaling transformation method designed by the inventors is adopted, i.e., the upper, lower, left, and right boundary values of the result of the above-described rotation transformation to be subjected to the translation transformation are randomly set, and then zero padding is performed. Then, a second proportional scaling is performed on the padding performed image according to a scaling factor, and the scaling factor is randomly selected within a range from 0.5 to 1.

In step 640, the extended transformation module 410 performs a perspective transformation on the result of the above-described translation scaling transformation according to a received transformation requirement input by a user. In this embodiment, the angle of the perspective transformation is relatively small, and parameters of the perspective transformation are randomly selected.

The step 310 may generate a corresponding character extension set by the above-described transformation steps 610-640. In this case, part of extended character images of the Chinese character “ [symbol] ” are shown in FIG. 9.

The merging module 420 may execute the step 320, specifically:

The merging module 420, according to the size of an extended character image corresponding to an extended character, extracts a background template region with a corresponding size in the background template, and performs a weighted merging process on the background template region and the extended character image to generate a synthesized character image. In this case, the weighted synthesis process is a linear weighted merging process, a weighting coefficient is determined by an average grayscale value of the background template region, the larger the average grayscale value, the smaller the weighting coefficient of the background template region, and the larger the weighting coefficient of the corresponding extended character image. A synthesized character image with a document background corresponding to an extended character image in FIG. 9 is shown in FIG. 10.

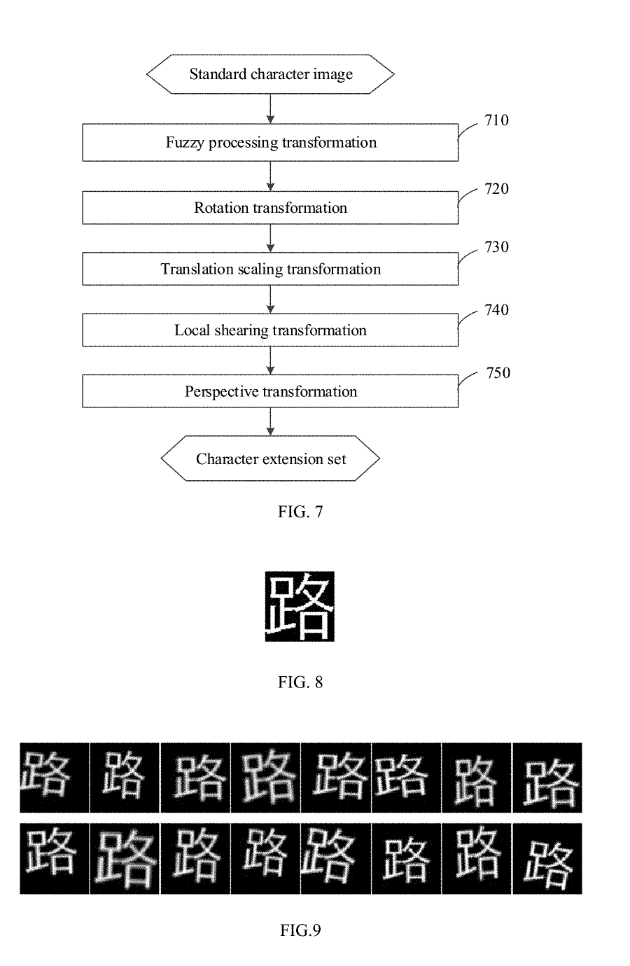

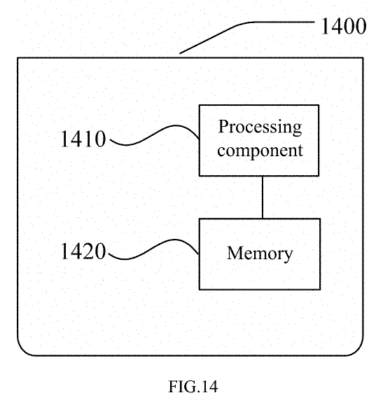

FIG. 7 is a schematic flow chart of corresponding transformation steps of a synthesis method of Chinese printed character images according to another embodiment of the present invention. FIG. 11 is a standard character image of the Chinese character “ [symbol] ” according to an embodiment of the present invention. FIG. 12 are part of extended character images of the Chinese character “ [symbol] ” according to an embodiment of the present invention. FIG. 13 are synthesized character images with a ticket background corresponding to extended character images in FIG. 12.

Referring to FIG. 3, FIG. 5 and FIG. 7, in an embodiment, the synthesis method of Chinese printed character images shown in FIG. 3 may executed by the synthesis device of Chinese printed character images shown in FIG. 5. In this case:

The character preprocessing module 430 may execute the step 302, specifically:

When the character requirement input by a current user is “standard Song font”, the character preprocessing module 430 automatically generates a Chinese first-class character, a Chinese second-class character, an English letter and a number in the standard Song font after receiving the character requirement input by the current user, performs a binarization process on the character to generate a standard character, and then saves the standard character as a standard character image corresponding to the standard character . A standard character image of the Chinese character “ [symbol] ” is shown in FIG. 11.

The background preprocessing module 440 may execute the step 304, specifically:

After a background image is input by a user, the background preprocessing module 440 receives the background image, determines a scaling ratio of the background image according to resolution of a character appeared in the input background image, and then performs a first proportional scaling in a bilinear interpolation or a bicubic interpolation manner to generate a corresponding background template. In this embodiment, resolution of a standard character image is 32×30, and resolution of a character appeared in the background image acquired in a practical application is 64×62, and the scaling ratio r of the background image is r=max(32,30)/max(64,62)=0.5.

The extended transformation module 410 may execute the step 310, specifically:

As shown in FIG. 7, the step may specifically include the following transformation steps:

In step 710, the extended transform module 410 receives the standard character image in the step 302, and performs a fuzzy processing transformation on the standard character image according to a received transformation requirement input by a user. In this embodiment, the transformation requirement input by the user includes latticed font required by the user, and therefore, the fuzzy processing transformation is a Lattice blurring transformation accordingly. Specifically, in this embodiment, the lattice fuzzy operator is a strip operator with a width of 1 pixel and a randomly generated height. In the Lattice blurring, a pixel point of a foreground character need to be randomly selected in a standard character image set including a standard character image, then a first region corresponding to a size of a lattice fuzzy operator is extracted by using the pixel point as a center point, and a dot-multiplication operation is performed with the first region and the lattice fuzzy operator. After repeating the dot-multiplication operation a plurality of times, a latticed character is obtained.

In step 720, the extended transformation module 410 performs a rotation transformation on the result of the above-described fuzzy processing transformation according to a received transformation requirement input by a user, and the angle of the rotation transformation does not exceed 5 degrees.

In step 730, the extended transformation module 410 performs a translation scaling transformation on the result of the above-described rotation transformation according to a received transformation requirement input by a user. In this embodiment, a simple and efficient translation scaling transformation method designed by the inventor is adopted, i.e., the upper, lower, left, and right boundary values of the result of the above-described rotation transformation to be subjected to the translation transformation are randomly set, and then zero padding is performed. Then a second proportional scaling is performed on the padding performed image according to a scaling factor, and the scaling factor is randomly selected within a range from 0.5 to 1.

In step 740, the extended transformation module 410 performs a local shearing transformation on the result of the above-described translation scaling transformation according to a received transformation requirement input by a user, which includes steps of selecting a second region along a horizontal or vertical direction on the standard character image to be subjected to the local shearing transformation and corresponding to the standard character, compressing the second region by keeping a height or a width of the second region unchanged to form a third region, and then replacing a corresponding region of the second region in the standard character image corresponding to the standard character with the compressed third region to generate a new image.

In step 750, the extended transformation module 410 performs a perspective transformation on the result of the above-described local shearing transformation according to a received transformation requirement input by a user. In this embodiment, the angle of the perspective transformation is relatively small, and parameters of the perspective transformation are randomly selected.

In the step 310 may generate a corresponding character extension set by the above-described transformation steps 710-750. In this case, part of extended character images of the Chinese character “ [symbol] ” are shown in FIG. 12.

The merging module 420 may execute the step 320, specifically:

The merging module 420, according to the size of an extended character image corresponding to an extended character, extracts a background template region with a corresponding size in the background template, and performs a weighted merging process on the background template region and the extended character image to generate a synthesized character image. In this case, the weighted merging process is a linear weighted merging process, a weighting coefficient is determined by an average grayscale value of the background template region, the larger the average grayscale value, the smaller the weighting coefficient of the background template region, and the larger the weighting coefficient of the corresponding extended character image. A synthesized character image with a ticket background corresponding to an extended character image in FIG. 12 is shown in FIG. 13.

From the above description, it can be seen that the above-described embodiments can generate an arbitrary number of extended characters through a plurality of transformations, and can quickly and effectively generate realistic character samples after merging with a background template to simulate changes in a practical application, thereby training a deep neural network model easily.

Especially for latticed font, latticed effect, needle leakage effect and local distortion effect in printed characters can be easily simulated by a lattice fuzzy operator, and a latticed Chinese printed character set can be constituted quickly, thereby improving synthesis efficiency significantly.

FIG. 14 is a block diagram of a computer device for implementing a synthesis method of Chinese printed character images according to an embodiment of the present invention.

Referring to FIG. 14, a device 1400 includes a processing component 1410 which further includes one or more processors and a memory resource represented by a memory 1420 which is used to store instructions, such as a computer program, executed by the processing component 1410. The computer program stored on the memory 1420 may include one or more modules, each of which corresponds to a set of the instructions. Additionally, the processing component 1410 is configured to execute the instructions so as to perform the above-described synthesis method of Chinese printed character images.

The device 1400 may further include a battery component configured to perform a battery management of the device 1400, a wired or wireless network interface configured to connect the device 1400 to a network and an input/output (I/O) interface. The device 1400 may operate an operating system stored on the memory 1420, such as Windows Server™, Mac OS X™, Unix™, Linux™, FreeBSD™ or the like.

A non-transitory computer readable storage medium enables the device 1400 to perform a synthesis method of Chinese printed character images when instructions on the storage medium are executed by the processors of the device 1400, and the method includes performing at least one transformation on a standard character image to respectively generate at least one extended character image, and respectively merging the at least one extended character image with a background template to generate at least one synthesized character image.

Those of ordinary skill in the art may appreciate that various exemplary modules and algorithm steps described in the embodiments disclosed herein may be implemented by an electronic hardware or a combination of a computer software and an electronic hardware. Whether these functions are performed by a hardware or a software depends on specific application and design constraint conditions of a technical solution. A person skilled in the art may use different methods to implement the described functions for each particular application, but such implementations should not be considered beyond the scope of the present invention.

A person skilled in the art may clearly understand that for the purpose of easy and brief description, the specific working process of the system, the device and the module described above may refer to the corresponding process in the above-described method embodiments, and details are not described herein again.

In the several embodiments according to the present application, it should be understood that the disclosed system, device, and method may be implemented in other manners. For example, the above-described device embodiment is merely illustrative. For example, the module division is merely logical function division and may be other division in actual implementation. For example, a plurality of modules or components may be combined or integrated into another system, or some features may be ignored or not performed. In addition, the displayed or discussed mutual couplings or direct couplings or communication connections may be implemented by using some interfaces. The indirect couplings or communication connections between the devices or modules may be implemented in electronic, mechanical, or other forms.

The module described as a separate part may be or may not be physically separated, and the part displayed as a module may be or may not be a physical module, i.e., may be located in one place, or may be distributed on a plurality of network modules. Some or all of the modules may be selected according to actual requirements to achieve the purposes of the solution of the embodiment.

In addition, each functional module in each embodiment of the present invention may be integrated into one processing module, or may exist alone physically, or two or more of the modules are integrated into one module.

When the functions are implemented in the form of a software functional module and sold or used as an independent product, the functions may be stored on a computer readable storage medium. Based on such an understanding, the technical solutions of the present invention essentially, or the part contributing to the prior art, or part of the technical solutions may be implemented in a form of a software product. The computer software product is stored on a storage medium, and includes several instructions for instructing a computer device (which may be a personal computer, a server, or a network device) to execute all or some of the steps of the methods described in the embodiments of the present invention. The foregoing storage medium includes any medium that can store program code, such as a USB flash drive, a removable hard disk, a read-only memory (ROM, Read-Only Memory), a random access memory (RAM, Random Access Memory), a magnetic disk, or an optical disc.

It should be understood that, each part of the present invention may be implemented by a hardware, a software, a firmware or a combination thereof. In the above embodiments of the present invention, a plurality of steps or methods may be implemented by a software or a firmware stored on a memory and executed by a proper instruction execution system.

In addition, each functional module in embodiments of the present invention may be integrated into one processing module, or each functional module may exist alone physically, or two or more of the modules are integrated into one module. The above-described integrated module may be achieved in the form of a hardware or in the form of s software functional module. If the integrated module is achieved in the form of a functional module and sold or used as a separate product, may be stored on a computer readable storage medium. The storage medium mentioned above may be a read only memory, a magnetic disk, an optical disk, etc.

It is to be noted that, the listed above are merely specific embodiments of the present invention, and it is obvious that the present invention is not limited to the above-described embodiments, followed by many similar variations. All variations directly derived from or associated with the present invention by those skilled in the art should be within the scope of the present invention.

1. A synthesis method of Chinese printed character images, comprising:
performing at least one transformation on a standard character image to respectively generate at least one extended character image;
and respectively merging the at least one extended character image with a background template to generate at least one synthesized character image.

2. The method according to claim 1, further comprising:
generating a character according to a preset character requirement;
performing a binarization process on the character to generate a standard character;
and saving the standard character as the standard character image.

3. The method according to claim 1, further comprising:
segmenting and extracting a character in the image character;
performing a binarization process and a first scaling transformation on the character to generate a standard character;
and saving the standard character as the standard character image.

4. The method according to claim 1, further comprising:
receiving a background image input by a user;
and generating the background template according to the background image.

5. The method according to claim 4, wherein the generating the background template according to the background image comprises:
performing a first proportional scaling transformation on the background image to generate the background template.

6. The method according to claim 5, wherein a scaling ratio of the first proportional scaling transformation is determined by a ratio of resolution of the standard character image to character resolution of the background image.

7. The method according to claim 1, wherein the at least one transformation comprises at least one of a fuzzy processing transformation, an affine transformation, a local shearing transformation and a perspective transformation.

8. The method according to claim 7, wherein the local shearing transformation comprises:
selecting a second region along a horizontal or vertical direction on the standard character image to be subjected to the local shearing transformation, and compressing the second region by keeping a height or a width of the second region unchanged to form a third region;
and replacing a corresponding region of the second region in the standard character image with the third region.

9. The method according to claim 1, wherein the respectively merging the at least one extended character image with a background template comprises:
according to a size of the extended character image, extracting a background template region with a corresponding size in the background template;
and performing a weighted merging process on the background template region and the at least one extended character image.

10. The method according to claim 9, wherein a weighting coefficient of the weighted merging process is determined by an average grayscale value of the background template region, and the average grayscale value is negatively correlated with the weighting coefficient.

11. A synthesis device of Chinese printed character images, comprising: a memory, a processor and a computer program stored on the memory and executed by the processor, wherein when the computer program is executed by the processor, the processor implements the following steps:
performing at least one transformation on a standard character image to respectively generate at least one extended character image;
and respectively merging the at least one extended character image with a background template to generate at least one synthesized character image.

12. The device according to claim 11, wherein the processor further implements the following steps:
generating a character according to a preset character requirement;
performing a binarization process on the character to generate a standard character;
and saving the standard character as the standard character image.

13. The device according to claim 11, wherein the processor further implements the following steps:
segmenting and extracting a character in the image character;
performing a binarization process and a first scaling transformation on the character to generate a standard character;
and saving the standard character as the standard character image.

14. The device according to claim 11, wherein the processor further implements the following steps:
receiving a background image input by a user;
and generating the background template according to the background image.

15. The device according to claim 14, wherein when implementing the step of generating the background template according to the background image, the processor specifically implements the following step:
performing a first proportional scaling transformation on the background image to generate the background template.

16. The device according to claim 15, wherein a scaling ratio of the first proportional scaling transformation is determined by a ratio of resolution of the standard character image to character resolution of the background image.

17. The device according to claim 11, wherein the at least one transformation comprises at least one of a fuzzy processing transformation, an affine transformation, a local shearing transformation and a perspective transformation.

18. The device according to claim 11, wherein when implementing the step of respectively merging the at least one extended character image with a background template, the processor specifically implements the following step:
according to a size of the extended character image, extracting a background template region with a corresponding size in the background template;
and performing a weighted merging process on the background template region and the at least one extended character image.

19. The device according to claim 18, wherein a weighting coefficient of the weighted merging process is determined by an average grayscale value of the background template region, and the average grayscale value is negatively correlated with the weighting coefficient.

20. A computer readable storage medium on which a computer program is stored, wherein when the computer program is executed by a processor, the processor implements the synthesis method of Chinese printed character images according to claim 1.
